(19) United States
(12) Patent Application Publication
(10) Pub. No.: US 2004/0049495 A1
(43) Pub. Date: Mar. 11, 2004

(54) System and method for automatically generating general queries

(76) Inventors: Chung-I Lee, Tu-Chen (TW); Chien-Fa Yeh, Tu-Chen (TW); Caiyang Luo, Shenzhen (CN); Tong Huang, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/286,249

(22) Filed: Oct. 31, 2002

(30) Foreign Application Priority Data
Sep. 11, 2002 (TW) 91120664

(51) Int. Cl. G06F 7/00

(52) U.S. Cl. 707/3

(57) ABSTRACT

A system for automatically generating general queries includes a server (120) and at least one client computer (110). Each client computer receives user queries, and includes a user processing module (111) and an XML converting module (113). The user processing module converts user queries into a query tree. The XML converting module converts the query tree into an XML query. The server includes a storage (125), an HTTP converting module (123), and a restriction table (121). A related method includes: (a) receiving user queries including an area code of an IP information website; (b) converting the user queries into a query tree; (c) converting the query tree into an XML query, and storing the XML query to an XML document; (d) converting the XML query into an HTTP query; (e) sending the HTTP query over the Internet; (f) storing a summary of a query answer in the XML document.

### BACKGROUND OF THE INVENTION

1. Field of the Invention

The present invention relates to systems and methods for automatically generating general queries, and particularly to a system and method for changing a first format query of a user into other format queries that various intellectual property (IP) information websites can identify.

2. Background of the Invention

With the development of electronic communications networks, information can be exchanged and used more efficiently than ever. With a client computer connected to a network, a user can access all kinds of information available on the network. A standard method for searching for information on a network is: logging on a private or public network; inputting key words related to the information in a specific query format of the network via an interface of the network; and acquiring the information needed.

Recently, query technology for information on a network has developed quickly. For example, a network robot can assist a user to search for information on a network. The network robot can track available network information sources, and ascertain the relevant information and features of each particular source. When the user sends a query to the robot, the robot determines which sources are relevant to the given query, forwards the query to the most relevant information sources, receives the responses returned from each source, and integrates and intelligently presents the query results to the user.

FIG. 7 is a schematic diagram of infrastructure of a system for querying information, as disclosed in U.S. Pat. No. 6,085,186. A network robot 700 mainly comprises a user interface 710, an integrator 720, and an input/output (I/O) manager 730. When a query 71 is input from the user interface 710, a query router 721 in the integrator 720 receives the query 71 and determines information sources related to the query. An aggregation engine 723 in the integrator 720 formats the query 71 according to a description of each relevant information source in a wrapper database (DB) 722. The I/O manager 730 transmits the formatted query to each of the relevant information sources 73 via a cache 731. After receiving responses returned from the relevant information sources 73, the I/O manager 730 forwards the responses to the aggregation engine 723, which then extracts data from the responses relevant to the query 71. Finally, the user interface 710 presents the extracted data in the form of an answer 72 to the user.

However, when this query system is used to search intellectual property (IP) information, the data finally received may not meet the user's requirements. The IP information can only be queried on private IP information websites, by the use of search engines thereof. In many instances, when a user queries IP information by inputting keywords, most of the information returned from the query system is not IP information. Instead, the returned information merely comprises the keywords themselves.

In addition, when the user wants to query IP information, he/she must log on a specific IP information website which provides the IP information needed. The IP information may, for example, be patent information. If the user wants to query another kind of IP information, he/she must log on another IP information website. Such other kind of IP information may, for example, be trademark information. Individual logging on multiple websites is unduly time consuming. Furthermore, each IP information website respectively has its own particular query format. The user must know the various query formats of different IP information websites. All the above-mentioned difficulties cause inconvenience, delay and confusion.

### SUMMARY OF THE INVENTION

Accordingly, it is a general object of the present invention to provide a system and method for automatically generating general queries which provides a general user interface from which a user can query IP information at various IP information websites.

It is another object of the present invention to provide a system and method for automatically generating general queries which can transform a first format query input by a user into another format query that can be identified by various IP information websites.

In order to accomplish the above-mentioned objects, the present invention provides a system for automatically generating general queries. The system comprises a server and at least one client computer. Each client computer is used for receiving user queries, and comprises a user processing module and an XML converting module. The user processing module comprises a graphical user interface (GUI) for users to input user queries. The user processing module is for prompting an error message if a user query is not correct, and for converting user queries into a query tree. The XML converting module is for converting the query tree into an XML query. The server comprises: a storage for storing XML documents each comprising at least one XML query; an HTTP converting module for converting an XML query into an HTTP query; and a restriction table for storing rules of conversion from the XML query to the HTTP query.

The present invention also provides a method for generating general queries, the method comprising the steps of: (a) receiving user queries including an area code of an IP information website; (b) converting the user queries into a query tree; (c) converting the query tree into an XML query, and storing the XML query to an XML document; (d) converting the XML query into an HTTP query; (e) sending the HTTP query over the Internet; and (f) storing a summary of a query answer in the XML document.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of infrastructure of a system for automatically generating general queries in accordance with a preferred embodiment of the present invention;

FIG. 2A illustrates a query tree representing users queries, in accordance with the preferred embodiment of the present invention;

FIG. 2B illustrates an XML query corresponding to the query tree of FIG. 2A;

FIG. 3 illustrates a restriction table in accordance with the preferred embodiment of the present invention;

FIG. 4 is a flow chart of generating a general query in accordance with a preferred embodiment of the present invention;

FIG. 5 is a flow chart of one step of FIG. 4, namely generating an XML query;

FIG. 6 is a flow chart of another step of FIG. 4, namely generating an HTTP query; and

FIG. 7 is a schematic diagram of infrastructure of a conventional system for querying information.

### DETAILED DESCRIPTION OF PREFERRED EMBODIMENTS OF THE INVENTION

Reference will now be made to the drawings to describe the present invention in detail.

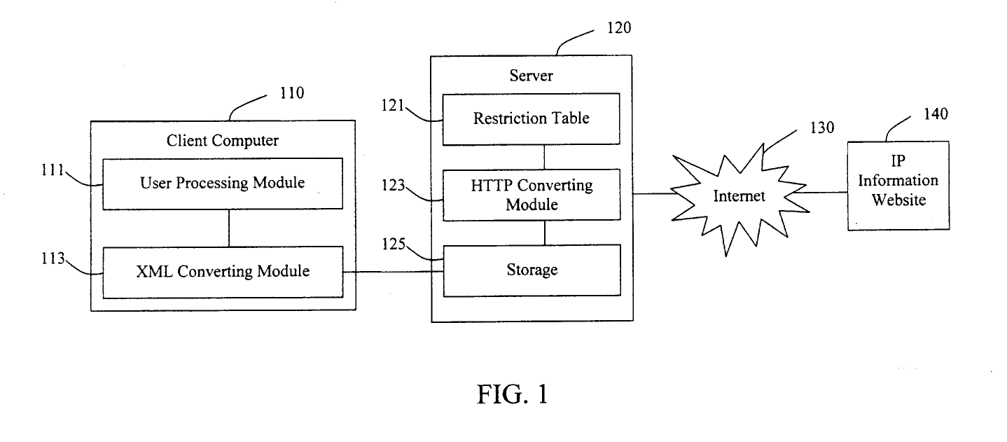

FIG. 1 is a schematic diagram of infrastructure of a system for automatically generating general queries in accordance with a preferred embodiment of the present invention. The system comprises a plurality of client computers 110 (only one shown) and a server 120. The server 120 connects with a plurality of intellectual property (IP) information websites 140 (only one shown) via the Internet 130.

Each client computer 110 is used for receiving users' input, and displaying results of implementation of data. The client computer 110 comprises a user processing module 111, and an Extensible Markup Language (XML) converting module 113. The user processing module 111 comprises a Graphical User Interface (GUI) for users to input user queries. The user queries must comprise some information on a relevant one of the IP information websites 140; for example, the code of an area where the relevant IP information website 140 is located at. The user processing module 111 can check the user queries, and prompt an error message when a user query is incorrect; for example, when a user query is illogical. The user processing module 111 also can convert the user queries into a single query tree.

In the preferred embodiment of the present invention, electronic patent documents downloaded from a desired IP information website 140 are stored in a plurality of projects. Each project stores a plurality of patent documents having some commonality, such as patent documents having the same assignee. All query information such as a summary of queries, time of implementation of queries, and a summary of query results on a project are stored in an XML document, and shown in the GUI of the user processing module 111. The user can modify original queries to generate a new query tree.

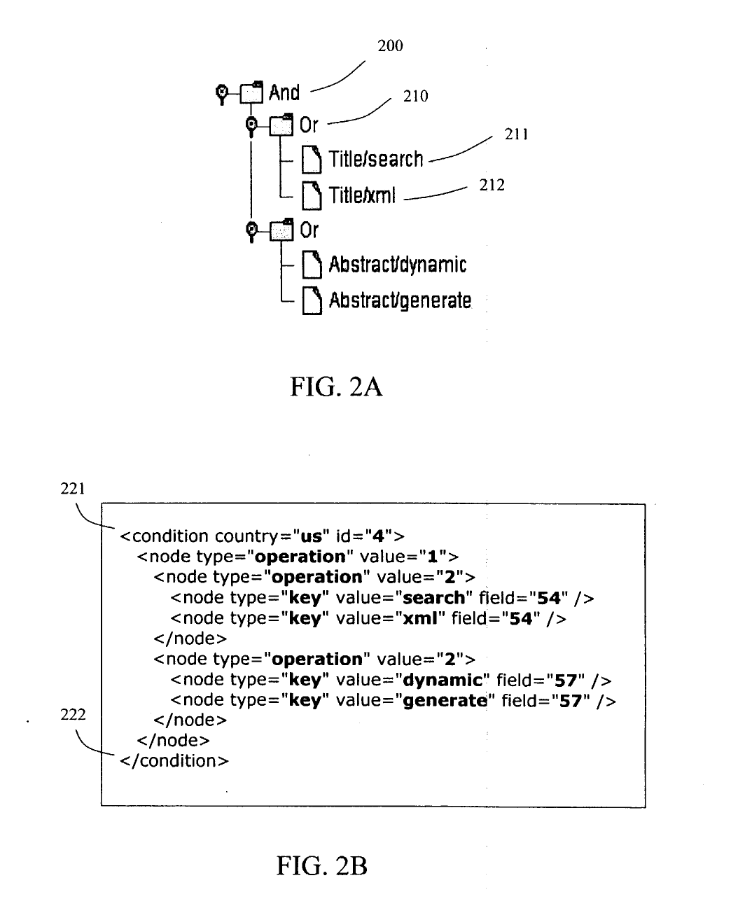

The XML converting module 113 is used for converting the query tree received from the user processing module 111 into an XML query. The procedure of such conversion is described below with reference to FIGS. 2A and 2B.

The server 120 comprises a restriction table 121, a Hypertext Transfer Protocol (HTTP) converting module 123, and a storage 125. The storage 125 is used for storing the XML queries. The XML queries belonging to a same project are stored in a same XML document. The HTTP converting module 123 is used for converting each XML query into an HTTP query, whereupon the HTTP query can be implemented in a designated IP information website 140.

Because of differences in query syntaxes among various IP information websites 140, the conversion from an XML query to an HTTP query is performed in accordance with the restriction table 121. The restriction table 121 defines a plurality of query syntaxes for a variety of IP information websites 140.

FIG. 2A illustrates a query tree representing user queries, in accordance with the preferred embodiment of the present invention. The query tree is compiled from the user queries, and comprises operations and operands. The operations include “and” 200, “or” 210 and “not.” Each operand corresponds to a user query. For example, the operand 211 represents searching for patent documents including the word “search” in a title of the patent document; and the operand 212 represents searching for patent documents including the word “xml” in a title of the patent document. The operation “or” 210 converts the operands 211 and 212 into a new operand for searching for patent documents including the word “search” or “xml” in title. The function of the operation “and” 200 is similar to the function of the operation “or” 210, insofar as the operation “and” 200 converts two or more operands into a new operand.

The query tree described above is a simple example of query trees that may be compiled. More operations and operands can be added into the above-described query tree to form a more complex logical query tree, whereby users can obtain more specific patent documents as desired.

FIG. 2B illustrates an XML query corresponding to the query tree of FIG. 2A. First, the source data upon which the invention operates must be specified using an outer-level grouping construct such as the beginning tag syntax “<condition country=“us” id=“4”>” shown at 221 and the ending tag syntax “</condition>” shown at 222. Other keywords, such as “node,” may be used in these outermost tags. FIG. 2B also illustrates that within the outermost structure, any number of nested substructures such as “node” may exist. What is required is that a predetermined keyword syntax is used to specify the source data, and the gathering process performed by the HTTP converting module 123 searches for this keyword syntax during conversion of the XML query into an HTTP query. The value of “id” (identifier) within this construct can be any syntactically correct value according to XML syntax, and will be used by the HTTP converting module 123 to locate the proper source data.

FIG. 2B further illustrates that the XML query contains values for the various data items. For example, the data item having identifier “country” has the value “us,” which means searching for patent documents in the United States Patent and Trademark Office (USPTO). The identifier “id=“4”” means that it is the fourth XML query in the XML document. The sequence of the XML queries appears in chronological order of when the XML queries were generated. Corresponding to the query tree, the data items of the XML query include operations (identified as “operation”) and operands (identified as “key”). Identifiers such as “1” and “2” are predetermined values assigned for various operations. The identifier “1” indicates the operation “and,” and the identifier “2” indicates the operation “or.” Identifiers such as “54” and “57” are predetermined values assigned for various fields of the operands. The identifier “54” indicates the field “title,” and the identifier “57” indicates the field “abstract.” As a whole, the identifier “<node type=“key” value=“dynamic” field=“57” />” is for searching for patent documents including the word “dynamic” in the abstract of the document.

The XML queries of the XML document are not restricted by coding. For example, words in American Standard Code for Information Interchange (ASCII), ISO 8859-X and GB2312 can be values of operands of the XML queries.

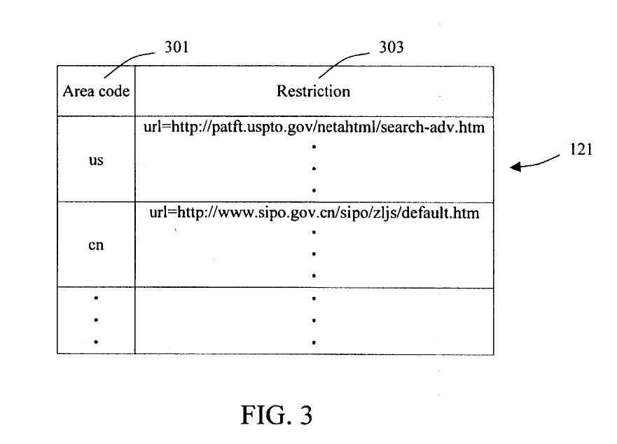

FIG. 3 illustrates a restriction table 121 in accordance with the preferred embodiment of the present invention. The restriction table 121 defines criteria for converting the XML queries into the HTTP queries, and comprises a plurality of area codes 301 and a plurality of corresponding restrictions 303. Each area code 301 is a keyword of the restriction table 121. The area code 301 stores a code representing an area in which the IP information website 140 to be searched is located. For example, “us” means the United States, and “cn” means China. Each item restriction 303 defines syntax of HTTP queries of a particular IP information website 140. The item restriction 303 comprises an Internet address of the IP information website 140, definitions of every field on the IP information website 140, restrictions of fields (e.g. contents of each field), and so on.

In an alternative embodiment of the present invention, the restriction table 121 can be replaced by an electronic document. Said document contains syntax definitions of HTTP queries for various IP information websites 140.

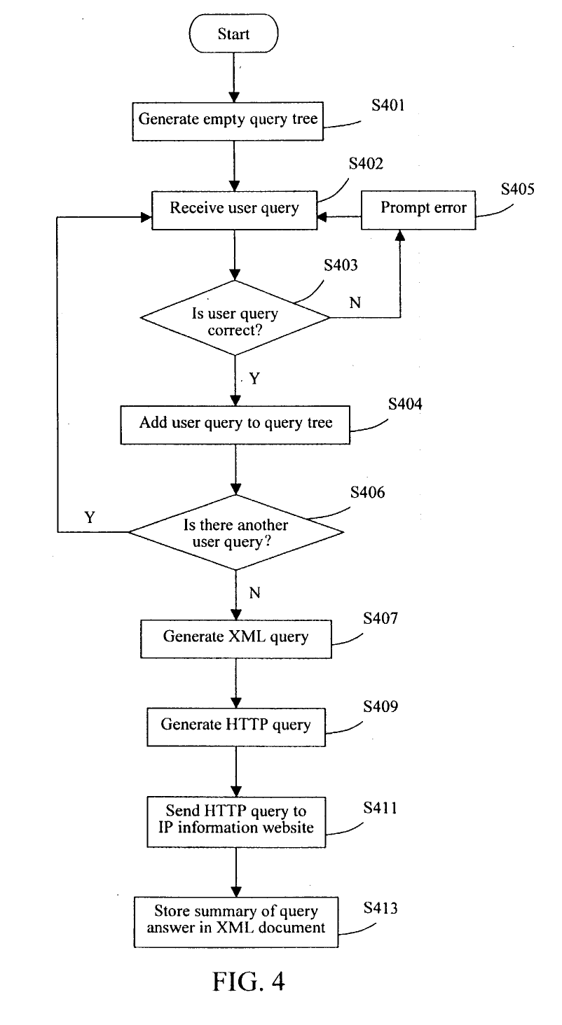

FIG. 4 is a flow chart of generating a general query in accordance with a preferred embodiment of the present invention. Firstly, in step S401, the user processing module 111 generates an empty query tree. In step S402, the user processing module 111 receives a user query via the GUI. In step S403, the user processing module 111 checks the user query. If the user query is incorrect, in step S405, the user processing module 111 prompts an error message via the GUI, and the procedure returns to step S402. If the user query is correct, in step S404, the user processing module 111 adds the user query to the query tree. In step S406, the user processing module 111 is advised by a user whether there is another user query to be added to the query tree. That is, if the user inputs an end queries command, the user processing module 111 sends the query tree to the XML converting module 113, and the procedure proceeds to step S407 described below. If the user inputs another user query into the user processing module 111 via the GUI, the procedure returns to step S402.

In step S407, the XML converting module 113 converts the query tree into an XML query, and stores the XML query in a corresponding XML document stored in the storage 125 of the server 120. In step S409, the HTTP converting module 123 converts the XML query into an HTTP query. In step S411, the HTTP query is sent to a corresponding IP information website 140 via the Internet 130. The IP information website 140 implements the HTTP query, and sends a query answer to the server 120. In step S413, the server 120 stores a summary of the query answer in said corresponding XML document. The summary of the query answer includes information such as a time of implementation of the HTTP query, and a total number of patent documents that match the HTTP query.

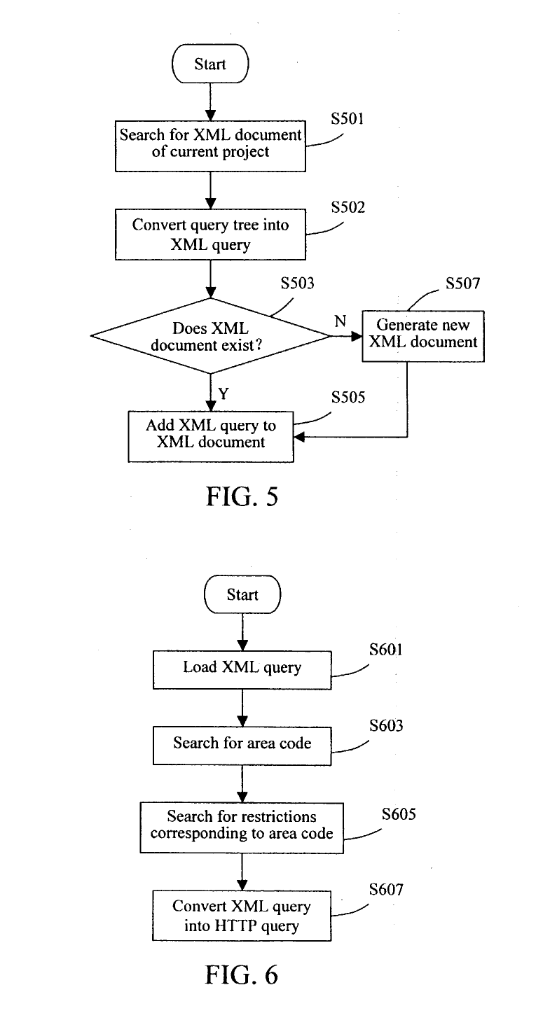

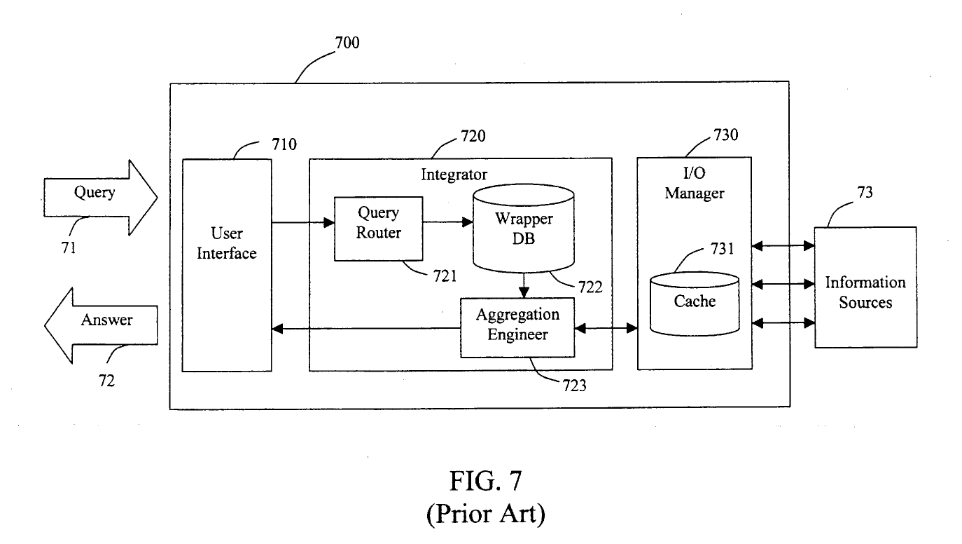

FIG. 5 is a flow chart of step S407 of FIG. 4, namely generating an XML query. In step S501, after receiving the query tree, the XML converting module 113 searches for an XML document of the current project. In step S502, the XML converting module 113 converts the query tree into an XML query. In step S503, the XML converting module 113 determines whether an XML document for the current project exists. If an XML document for the current project does not exist, in step S507, the XML converting module 113 generates a new XML document for the current project. If and when an XML document for the current project exists, in step S505, the XML converting module 113 adds the XML query to the XML document for the current project.

FIG. 6 is a flow chart of step S409 of FIG. 4, namely generating an HTTP query. Firstly, in step S601, the HTTP converting module 123 loads the XML query from the XML document stored in the storage 125. In step S603, the HTTP converting module 123 searches for an area code in the XML query. In step S605, the HTTP converting module 123 searches for restrictions in the restriction table 121 corresponding to the area code. In step S607, the HTTP converting module 123 converts the XML query into an HTTP query in accordance with the corresponding restrictions.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for automatically generating general queries, the system comprising:
at least one client computer for receiving user queries, the at least one client computer comprising a user processing module and an extensible markup language (XML) converting module, wherein:
the user processing module comprises a graphical user interface for inputting user queries, and the user processing module is for prompting error messages if user queries are not correct, and for converting user queries into a query tree; and
the XML converting module is for converting the query tree into an XML query; and
a server comprising:
a storage for storing XML documents each comprising at least one XML query;
a hypertext transfer protocol (HTTP) converting module for converting an XML query into an HTTP query; and
a restriction table for storing rules of conversion from the XML query to the HTTP query.

2. The system as claimed as claim 1, wherein the restriction table is replaced by a restriction document.

3. The system as claimed as claim 1, wherein the restriction table includes data items for area code and restriction, and the data items for restriction define syntax for HTTP queries for particular intellectual property (IP) information websites.

4. The system as claimed as claim 1, wherein the restriction table uses area codes as keywords, and comprises Internet addresses of IP information websites and syntax for HTTP queries for the IP information websites.

5. The system as claimed in claim 1, wherein the HTTP query can be implemented in a designated IP information website.

6. A method for automatically generating general queries, the method comprising the steps of:
receiving user queries including an area code of an IP information website;
converting the user queries into a query tree;
converting the query tree into an XML query, and storing the XML query to an XML document;
converting the XML query into an HTTP query;
sending the HTTP query over the Internet;
storing a summary of a query answer in the XML document.

7. The method as claimed in claim 6, wherein the XML document stores XML queries belonging to a same project.

8. The method as claimed in claim 6, further comprising the step of: checking whether the user queries are correct, and prompting an error message if a user query is not correct.

9. A method for automatically generating general queries, the method comprising the steps of:
receiving user queries;
checking whether the user queries are logical, and prompting an error message if a user query is not logical;
converting the user queries into a query tree;
converting the query tree into an XML query, and storing the XML query to an XML document;
converting the XML query into an HTTP query;
sending the HTTP query over the Internet;
storing a summary of a query answer in the XML document.

10. A method of automatically searching information from different information sources, comprising steps of:
providing a plurality of information sources equipped with different search engines internally;
providing a user processing module equipped with a universal search engine for receiving query; and
providing a converting module with capability of automatically transforming search query initiated from said universal search engine to those recognized by said different search engines, respectively and selectively; wherein
the users are not required to manually operatively visit said information sources respectively while allowed to obtain all requested information from respective information sources via a single visit on a single site having said universal search engine and the associated converting module.

11. The method as claimed in claim 10, wherein said different information sources use at least two different languages.

12. The method as claimed in claim 11, wherein said different information sources are a plurality of patent database web sites provided by different countries using respective search methods.

13. The method as claimed in claim 12, wherein a same invention is allowed to be found in said different information sources, respectively.
